(19) United States
(12) Patent Application Publication
(10) Pub. No.: US 2006/0218724 A1
(43) Pub. Date: Oct. 5, 2006

(54) Bed having tiltable section

(76) Inventor: Jerry Blevins, Toms Brook, VA (US)

Correspondence Address: HOFFMAN, WASSON & GITLER. P.C., Suite 522, 2461 South Clark Street, Arlington, VA, 22202, US

(21) Appl. No.: 11/394,043

(22) Filed: Mar. 31, 2006

Related U.S. Application Data
(60) Provisional application No. 60/667,072, filed on Apr. 1, 2005.
(60) Provisional application No. 60/679,244, filed on May 10, 2005.

(51) Int. Cl. A61G 7/14

(52) U.S. Cl. 5/81.1 R; 5/86.1

(57) ABSTRACT

The patient transfer device has a support surface tiltable about a horizontal axis to facilitate rotation of a patient from the tiltable surface to another surface. The support surface may be cantilevered from a post. The height of the support surface is adjustable, allowing the support to be placed on a bed. The tilting of the support surface facilitates the transfer of the patient from the transfer device to the bed. The transfer device may also be a bed having two sections, each one tiltable towards the other to transfer the patient from one side to the other. The halves may be unitary or separable, allowing one half to be moved away from the other.

This application claims benefit of Provisional Application Ser. Nos. 60/667,072, filed Apr. 1, 2005 and 60/679,244, filed May 10, 2005.

### BACKGROUND OF THE INVENTION

Patients in hospitals and nursing homes often need to be transported about the facility. Part of transportation is safely and efficiently moving a patient from a bed to a gurney. Transfer must be accomplished with as little discomfort to the patient and with as few people possible.

In addition to having a gurney which can be positioned close to a patient's bed, the ability for the support surface of the gurney to overlie the bed facilitates transfer. Even with the gurney overlying the bed, the process of transferring a patient from gurney to bed often needs two or more people and can be uncomfortable for the patient.

It is an object of the invention to provide a patient transfer device facilitating transfer between the device and a bed.

It is another object of the invention to provide a spacious support surface tiltable to facilitate rotation of a patient.

It is another object of the invention to provide a device reducing the number of people and discomfort involved in patient transfer.

These and other objects of the invention will become apparent to one of ordinary skill in the art after reading disclosure of the invention.

### SUMMARY OF THE INVENTION

The patient transfer device has a support surface tiltable about a horizontal axis to facilitate rotation of a patient from the tiltable surface to another surface. The support surface may be cantilevered from a post. The height of the support surface is adjustable, allowing the support to be placed on a bed. The tilting of the support surface facilitates the transfer of the patient from the transfer device to the bed. The transfer device may also be a bed having two sections, each one tiltable towards the other to transfer the patient from one side to the other. The halves may be unitary or separable, allowing one half to be moved away from the other.

### BRIEF DESCRIPTION OF THE DRAWINGS

FIG. 1 is a prospective view of the patient support transfer device.

FIG. 2 is a front view of the patient support transfer device.

FIG. 3 is an end view of the patient support transfer device showing a change in elevation.

FIG. 4 is an end view of the patient support transfer device showing the tiltable support surface.

FIGS. 5A-5E demonstrate the transfer process.

FIG. 6 is a perspective view of the second patient support transfer device.

FIG. 7 is a front view of the patient support transfer device.

FIGS. 8A-8I show the patient transfer process.

FIGS. 9-14 depict the transfer of a patient from a gurney to a bed having an inclined support surface.

FIGS. 15-18 depict patient transfer on a bed having a hinged middle.

FIGS. 19-22 depict the support surface of FIGS. 15-18 formed as separate elements.

### DETAILED DESCRIPTION OF THE INVENTION

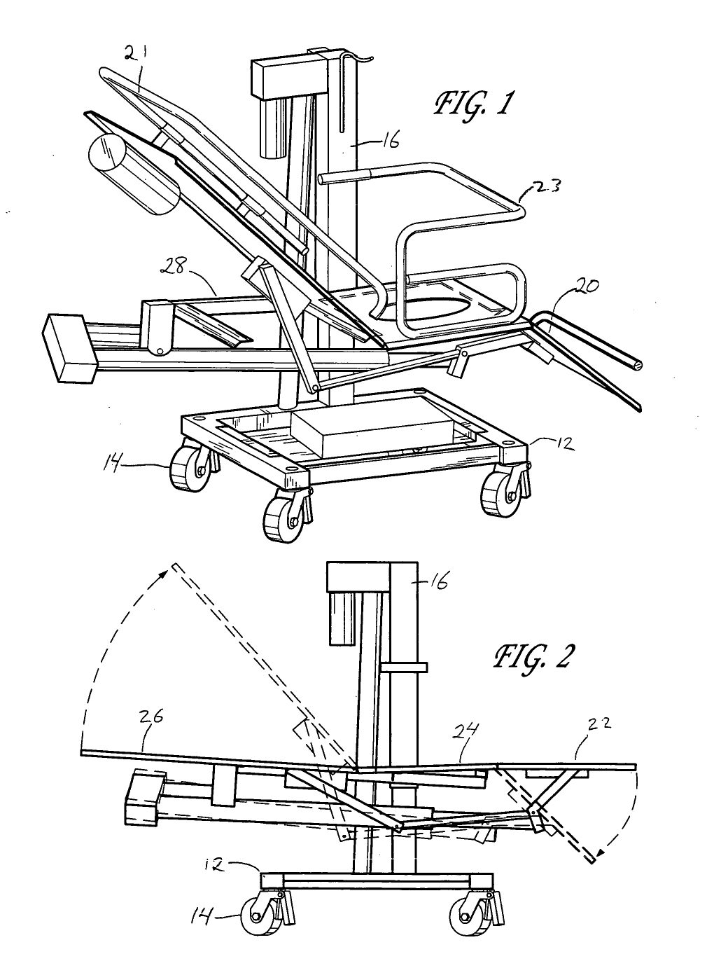

FIG. 1 shows the patient transfer device having a base 12 mounted on wheels 14 for easy movement of the device. A tower 16 extends upwardly from the base 12 and supports the patient support surface 20. The support surface is preferably paded, as with a mattress. An upper railing 21 and lower railing 23 surround the periphery of the patient support 20. As seen in FIG. 2, the patient support is formed by three sections including a foot portion 22, a central portion 24 and a head portion 26. The mechanism below the support surface allows movement between a seated and flat position. FIG. 3 shows the end view of the patient transfer device with the tower 16 telescoping to raise and lower the patient support surface 20. The patient support surface 20 is attached to the frame 28. Such a patient transfer device is disclosed in U.S. Pat. No. 5,996,150, herein incorporated by reference.

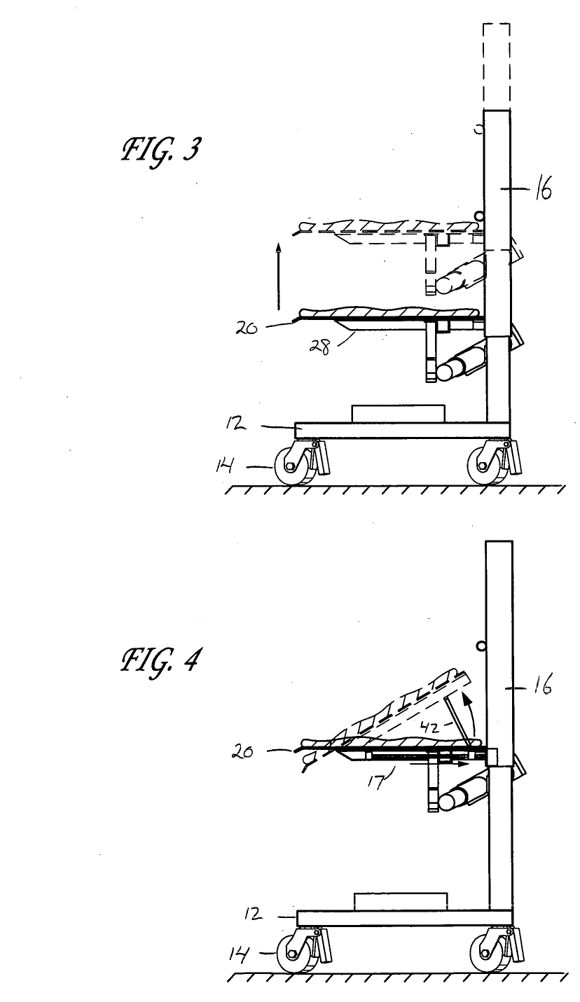

FIG. 4 shows the ability of the bed 20 to tilt about horizontal axis. The side of the bed nearest the post 16 raises upwardly. Any mechanism capable of raising the near side of the patient support may be used. One such mechanism is a screw jack extending outwardly from the post. As the rod 42 moves along the screw jack 17, the rod lifts the near side of the support surface. The advantage of this will become apparent from the foregoing discussion.

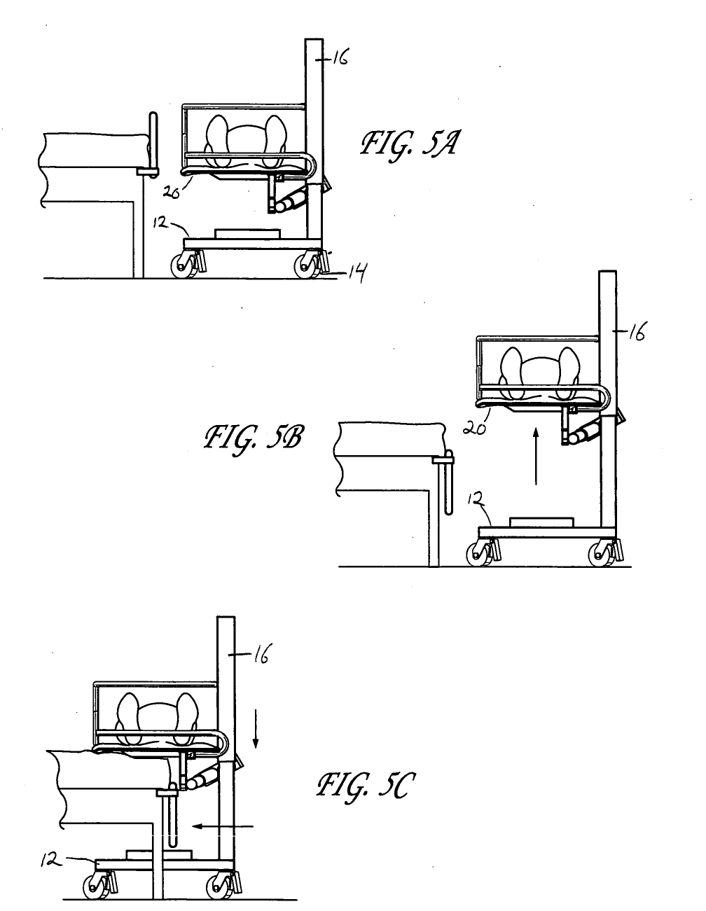

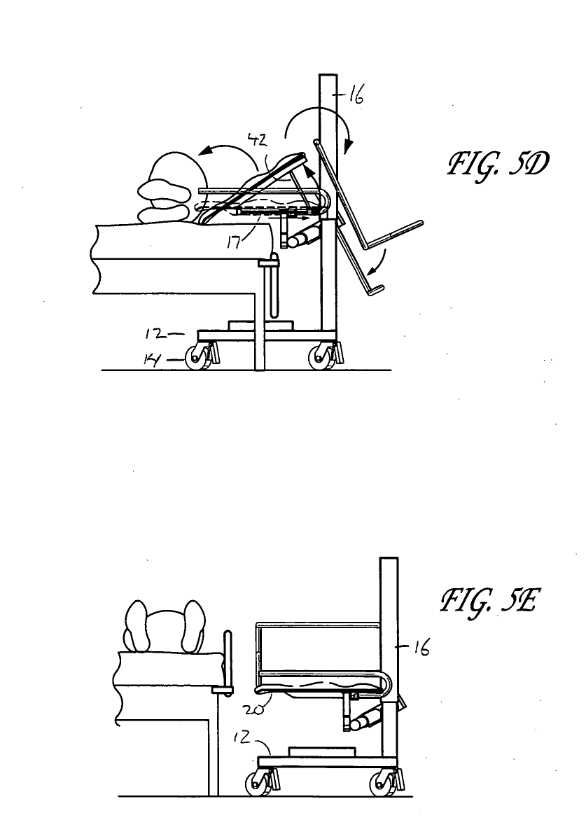

FIGS. 5A-5E show the transfer of the patient. In FIG. 5A, the device is placed in proximity to a bed. As seen in FIG. 5B, the base of support 20 is raised above the level of the bed. The base to support is placed over the bed and lowered until it contacts the bed as seen in FIG. 5C. The guards 21, 23 are pivoted out of the way and the support 20 is tilted, as seen in FIG. 5D. In this position, the patient is rotated off of the patient support 20 and onto the bed. Thereafter, the device can be moved away from the bed.

FIG. 6 shows and alternative embodiment of the patient transfer device having a pair of bases 30, each with a post 34 extending upwardly therefrom. Extending between and connected to the post 34 is the patient support 38. Extending between the top of the post is a piston/cylinder 40. As seen in FIG. 7, movement of the piston/cylinder causes movement of the posts 34 and the raising and lowering of the patient support 38. Such a patient transfer device is disclosed in U.S. Pat. No. 6,651,280, herein incorporated by reference.

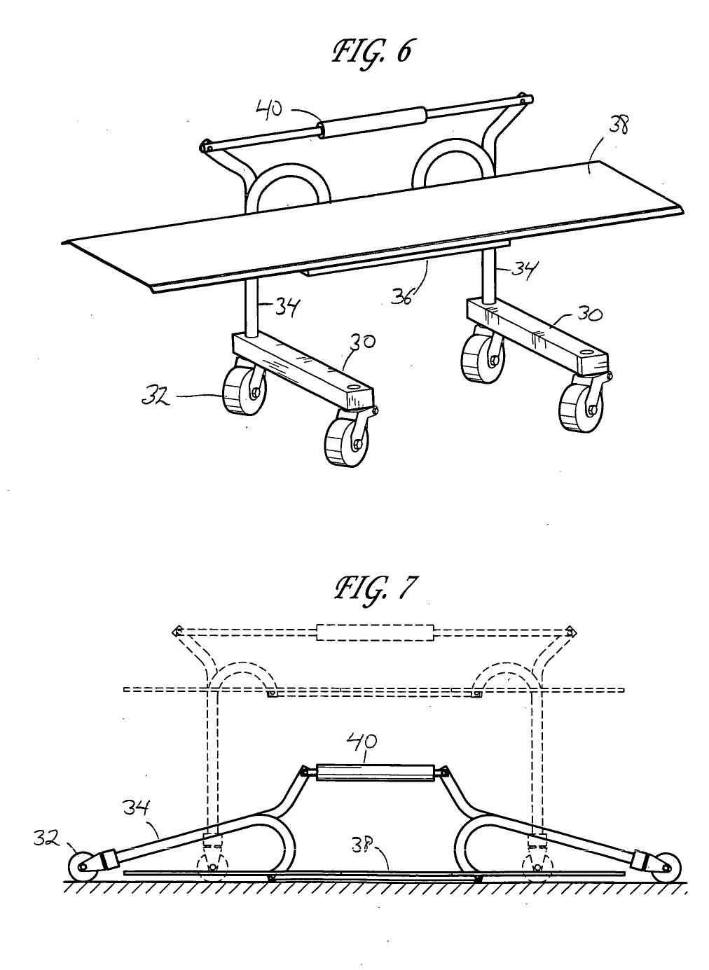

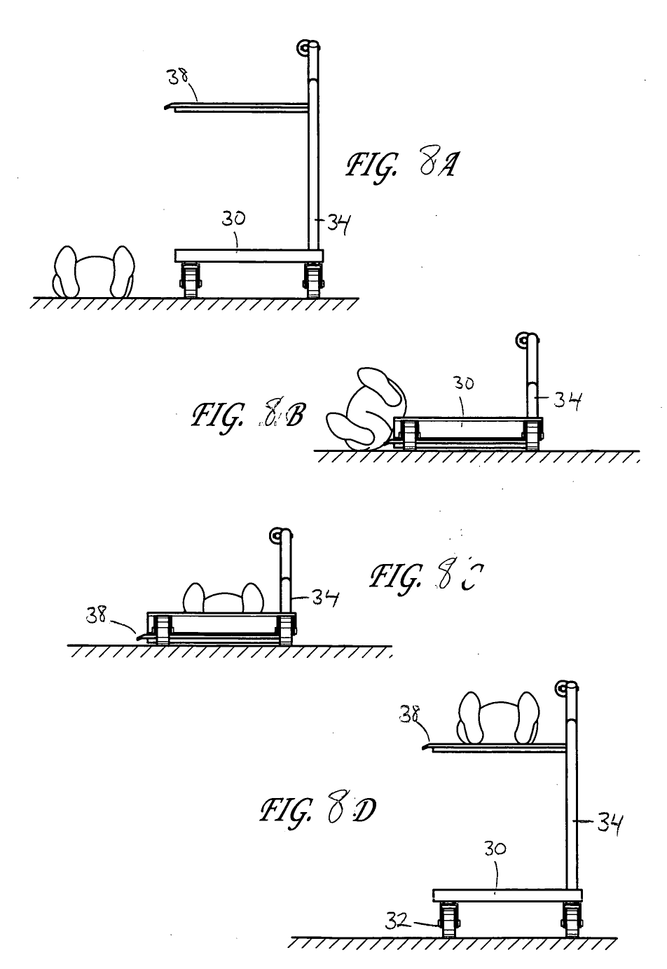

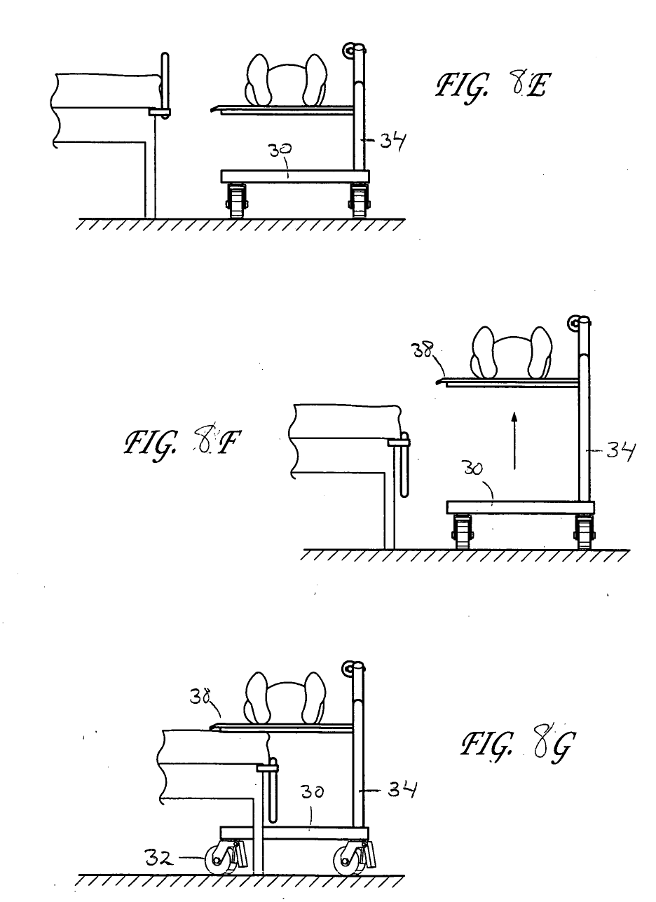

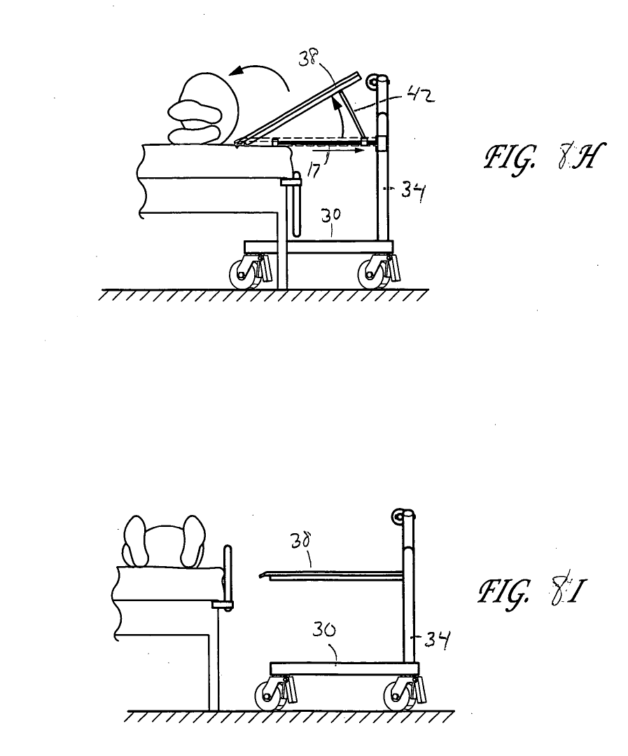

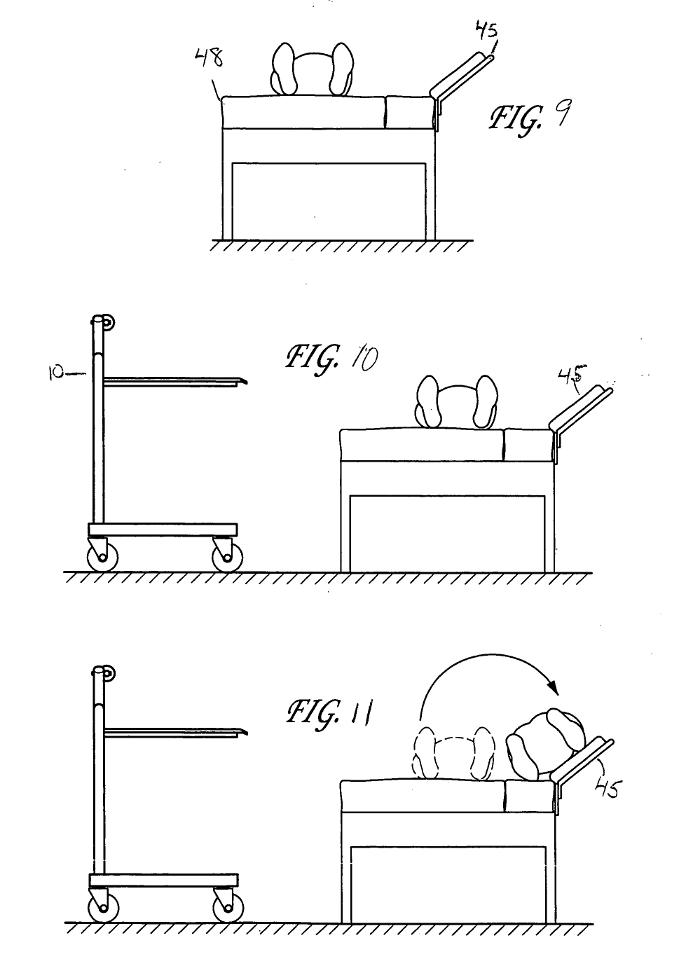

FIGS. 8A-8I depict the transfer of a patient from the floor onto the patient transfer device. The device is placed near the patient, the support is lowered to the ground. As seen in FIGS. 8B and 8C, the patient is rotated to allow the patient transfer device to be placed under the patient and the patient is rotated onto the support 38. The support 38 is then raised and moved in proximity to a bed as seen in FIG. 8E. Thereafter, the patient support is placed to be overlying the bed and the support is tilted by use of a rod 42 as seen in FIG. 8H and explained earlier in reference to FIG. 4. The patient is rotated off the support 38 and the patient transfer device moved away from the bed.

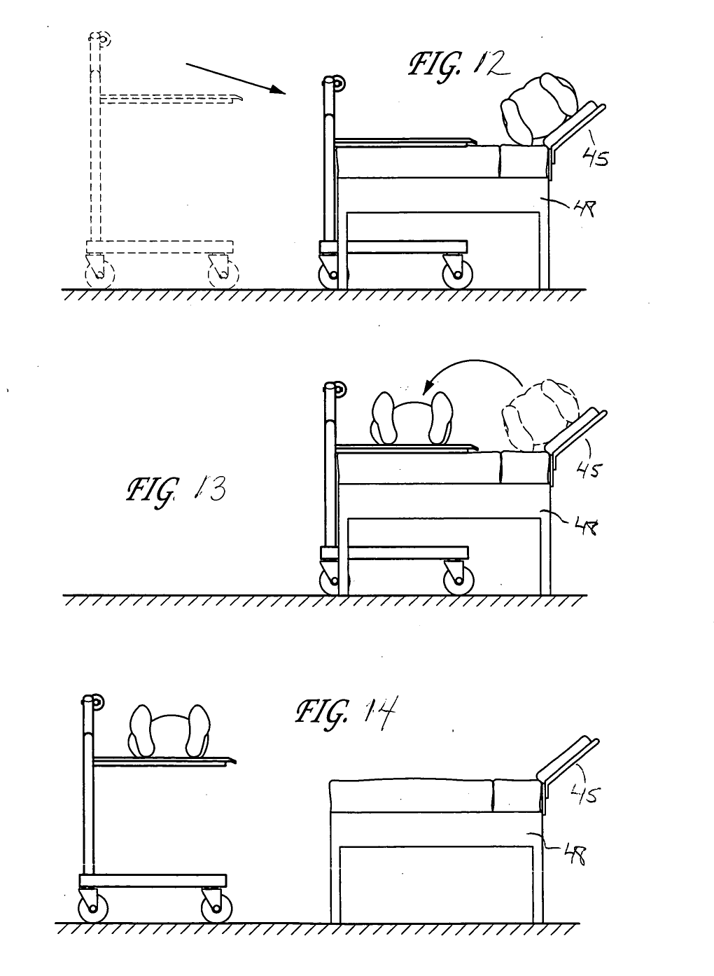

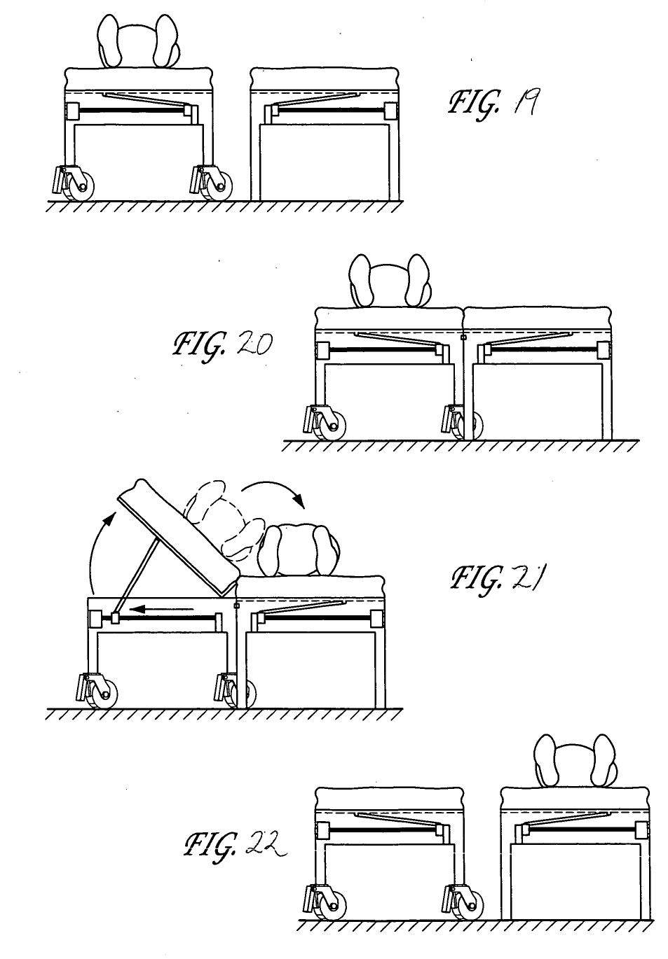

FIG. 9 depicts a bed having a stationary inclined surface 45 extending from the side of a bed 48. Both the bed and inclined surface are padded. Any patient transfer device 10 may be used with this bed 48. The patient is rotated so as to be supported by the incline section 45. Once positioned on the inclined surface, the patient transfer device is placed onto the bed 48 and the patient is rotated back onto the patient transfer device 10. The transfer procedure is depicted in FIGS. 20-14 and, needless to say, the process can be reversed to transfer a patient from the transport device 10 onto the bed 48.

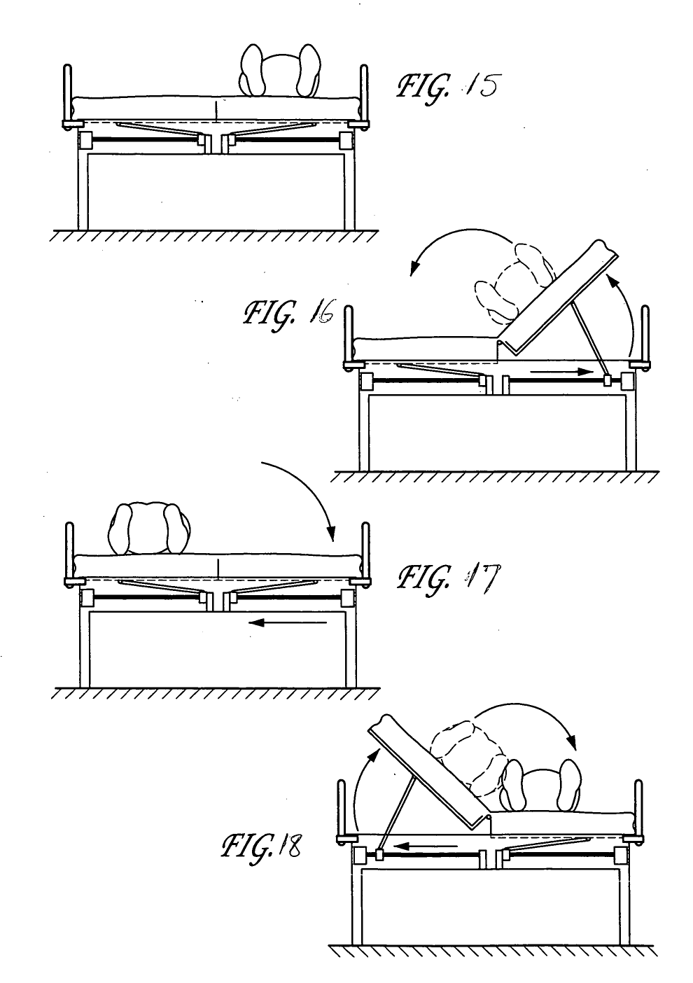

FIG. 15 depicts a bed having two sections pivoted together. The pivot runs along the long side of a bed. A screw jack is connected to each section of the bed for allowing tilting of the section toward the other section. As seen in FIGS. 15 and 16, the right side of the bed can be tilted up to rotate the patient to the opposite side. In so doing, the patient is changed from being on his back, as seen in FIG. 15, to being on his stomach, as seen in FIG. 17. Needless to say, FIG. 18 depicts the tilting of the left side of the bed to rotate the patient back to the original position. This rotation prevents bed sores, allows a transfer device to be placed over one half and facilitates changing of sheets.

FIGS. 19-22 show the beds of FIGS. 15-18 formed as two separate pieces. The left side of the bed is formed with wheels. As seen in FIG. 20, the two sections can be secured to one another with any conventional latch or similar device. Tilting of the left side of the bed transfer the patient from the movable section to the stationary section. In this manner, patients can be transported on the movable section and easily transported to the stationary portion.

While the invention has been described with reference to the preferred embodiment, variations and modifications would be apparent to one of ordinary skill in the art. Such modifications and variations are within the scope of the invention.

I claim:

1. A patient transfer device comprising
a frame,
a patient supported by said frame,
said patient support having two side and two ends, said sides being longer than said ends,
said patient support being tiltable relative to said frame along an axis parallel to said sides.

2. The patient transfer device of claim 1 wherein said patient support is cantilevered from said frame.

3. The patient transfer device of claim 2, wherein said patient support can be raised and lowered.

4. The patient transfer device of claim 1, further comprising a jack for tilting the patient support.

5. The patient transfer device of claim 4, wherein
said jack comprises a threaded member attached to the frame, and
a rod having one end connected to said threaded member and another end attached to said patient support.

6. The patient transfer device of claim 1, wherein
said axis is located between the two sides of the patient support to form two sections, each section tiltable about said axis.

7. The patient support of claim 6, further comprising
a jack attached to each section for tilting the section.

8. The patient transfer device of claim 6, wherein said frame is separable along said axis.

9. A bed comprising
a frame,
a support surface supported by the frame, and
a second section adjacent said support surface, the second section at an angle with said support surface.

10. The bed of claim 9, wherein said support surface and second section are padded.

11. The bed of claim 9, wherein said second section is movable between a tilted position and a flat position.
